(19) United States
(12) Patent Application Publication
(10) Pub. No.: US 2013/0256988 A1
(43) Pub. Date: Oct. 3, 2013

(54) IMAGE FORMING APPARATUS

(71) Applicants: Atsushi TAKAHASHI, Tokyo (JP); Hiroshi OYAMA, Tokyo (JP)

(72) Inventors: Atsushi TAKAHASHI, Tokyo (JP); Hiroshi OYAMA, Tokyo (JP)

(73) Assignee: Konica Minolta Business Technologies, Inc., Tokyo (JP)

(21) Appl. No.: 13/851,785

(22) Filed: Mar. 27, 2013

(30) Foreign Application Priority Data
Apr. 3, 2012 (JP) 2012-84763

(51) Int. Cl. B41J 13/00

(52) U.S. Cl. CPC B41J 13/00
USPC 271/270; 271/264

(57) ABSTRACT

When conveyance checking mode is selected, an automatic setting screen is changed. In the automatic setting screen, components such as AD rollers, guide plates or sheet ejection rollers, which are used when conveying the sheet of paper, are selectable. When the components are selected, they are highlighted in color and their names are also represented. The sheets of paper stop at their stop positions corresponding to the selected components. A user removes the sheets of paper from their stop position and checks an image pattern formed on each of the removed sheets of paper.

### CROSS REFERENCE TO RELATED APPLICATION

The present invention contains subject matter related to Japanese Patent Application JP 2012-84763 filed in the Japanese

Patent Office on Apr. 3, 2012, the entire contents of which being incorporated herein by reference.

### BACKGROUND OF THE INVENTION

1. Field of the Invention:

The present invention relates to an image forming apparatus that forms an image on a sheet of paper, such as a copy machine, a facsimile, a printer and a multifunction printer.

2. Description of Related Art:

Various kinds of image forming apparatuses that can identify a component thereof in which any problem occurs have been proposed. For example, Japanese Patent Application Publication No. H06-316134 discloses a printer which identifies a jam occurring position therein when the jam occurs and informs a user how to remove such a jammed sheet of paper. Japanese Patent Application Publication No. 2010-162764 discloses an image forming apparatus which identifies a position in which an extraordinary event such as a jam occurs in the conveyance and stops only feeding electric power to the drive means related to the position. Japanese Patent Application Publication No. 2004-287310 discloses an image forming apparatus which when a jam sensor detects that a jam occurs, a movable unit is moved to a jam occurring position and a camera provided on the movable unit photographs the jam occurring position.

### SUMMARY OF THE INVENTION

By the way, as any problems generated in the image forming apparatus, in addition to such a jam, there are any image defects such as image cracks, a roller trace and/or a scratch, which are generated by conveying rollers or guide plates for conveying the sheet of paper during a conveyance of the sheet of paper. In this case, it maybe required to check each conveying roller and the guide plates in the apparatus. Japanese Patent Application Publication No. H06-316134, however, discloses the image forming apparatus which identifies a jam occurring position or the like but does not disclose to check the guide plates and the like in the apparatus.

Although a general image forming apparatus has measured a potential of photoreceptor as a method of checking a defect in the component of the image forming apparatus and has checked durability of the conveying rollers based on the conveying timing thereof, there has been nothing to check the conveying rollers and the guide plates in the image forming apparatus.

Accordingly, in the past image forming apparatus, when any image defects such as image cracks, a roller trace and/or a scratch occur, it is difficult to identify an image defect occurring position.

This invention solves the above-mentioned problem and has an object to provide an image forming apparatus which may identity a position in which the image defect such as image cracks occurs.

To achieve the above-mentioned object, an image forming apparatus reflecting one aspect of the present invention contains a sheet conveying portion that conveys the sheet of paper in the image forming apparatus, a setting portion that sets a stop position of the sheet of paper conveyed by the sheet conveying portion, and a control portion that controls the sheet conveying portion to stop the sheet of paper at the stop position set by the setting portion, wherein the setting portion selects any of plural stop positions as the stop position of the sheet of paper, and the control portion is configured so as to stop a number of sheets of paper according to a number of the plural stop positions at the selected plural stop positions when the setting portion selects the plural stop positions.

It is desirable to provide the image forming apparatus further containing a display portion that displays the stop positions set by the setting portion.

It is also desirable to provide the image forming apparatus wherein the setting portion selects as the stop positions components used for conveying the sheet of paper, and when the setting portion selects the components, the control portion controls the display portion to display information about the selected components.

It is still desirable to provide the image forming apparatus wherein the information about the selected components is at least one piece of information of name information of the components and identification number information of the components.

It is further desirable to provide the image forming apparatus wherein the setting portion sets to move each of the sheets of paper from their stop positions after the sheets of papers stop at their stop positions, and the control portion controls the sheet conveying portion to move each of the sheets of paper from their stop positions according to an amount of movement set by the setting portion when the setting portion sets to move each of the sheets of paper from their stop positions after the sheets of paper stop at their stop positions.

It is additionally desirable to provide the image forming apparatus wherein the setting portion sets the stop positions of the sheets of paper at optional positions, and the control portion controls the sheet conveying portion to stop the sheets of paper at any of the stop positions when the setting portion sets the stop positions of the sheets of paper at the optional positions.

It is still further desirable to provide the image forming apparatus wherein the setting portion sets a conveying speed of each of the sheets of paper to a conveying speed of each of the sheets of paper that is different from a conveying speed of each of the sheets of paper in image forming control time when the image is formed on each of the sheets of paper.

It is still additionally desirable to provide the image forming apparatus wherein the control portion controls the sheet conveying portion to stop the sheets of paper, which are used under an image forming control to form the image on the sheets of paper, at the stop positions set by the setting portion.

It is still further desirable to provide the image forming apparatus wherein the setting portion selects at least one of sheet conditions among a feeding tray for containing the sheets of paper, a species of the sheet of paper and a size of the sheet of paper, and the control portion controls the sheet conveying portion to stop the sheets of paper, which are used based on the sheet condition selected by the setting portion, at their stop positions set by the setting portion.

The stop positions in this invention correspond to, for example, installed positions of the components such as the conveying rollers and the guide plates, which are used when conveying the sheet of paper. The sheet conveying portion relates to sheet conveying device and relates to, particularly, the rollers for conveying the sheet of paper and a driving motor for driving these rollers. When the setting portion sets the stop positions by a user or a service man, the control portion controls the sheet conveying portion to stop the sheet of paper at any of the stop positions, which are set by the setting portion, for example, on any of the components or a stop position before or after the component. Accordingly, it is possible to check whether or not the image defects occur based on this component by removing the sheet of paper from the component corresponding to the stop position by the user or the service man and checking an image pattern represented on the removed sheet of paper by him.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a diagram of an image forming system according to an embodiment of this invention showing a configuration example thereof;

FIG. 2 is a block diagram showing a configuration example of an image forming apparatus;

FIG. 3 is an illustration of a menu screen showing a configuration example thereof;

FIG. 4 is an illustration of an automatic/manual selection screen showing a configuration example thereof;

FIG. 5 is an illustration of an automatic setting screen showing a configuration example thereof;

FIG. 6 is an illustration of a manual setting screen showing a configuration example thereof;

FIG. 7 is a flowchart (Part one) showing an operation example of the control portion during conveyance checking mode;

FIG. 8 is a flowchart (Part two) showing an operation example of the control portion during conveyance checking mode;

FIG. 9 is a flowchart showing an operation example of the control portion on automatic setting time;

FIG. 10 is an illustration of a stop-position-condition-setting screen showing a configuration example thereof;

FIG. 11 is a flowchart showing an operation example of the control portion on test printing time;

FIG. 12 is a flowchart showing an operation example of the control portion on manual setting time; and

FIG. 13 is an illustration of the stop-position-condition-setting screen showing a configuration example thereof.

### DESCRIPTION OF THE PREFERRED EMBODIMENTS

The following will describe embodiments of an image forming apparatus relating to the invention with reference to drawings. It is to be noted that the description in the embodiments is exemplified and any technical scope of the claims and/or meaning of term(s) claimed in the claims are not limited thereto.

### [Configuration Example of Image Forming Apparatus]

The image forming apparatus 100 is provided with a conveyance checking mode in which the stop position(s) on which the sheet(s) of paper is (are) stopped in the image forming apparatus is (are) selected on a screen and the sheet(s) of paper P is (are) stopped on the selected stop position(s). The image forming apparatus 100 stops the sheet(s) of paper P at the predetermined stop position(s) during the conveyance checking mode and the user or the like checks an image pattern formed on the sheet(s) of paper P so that it is easily possible to check where the image defects of the sheet(s) of paper occur in the image forming apparatus.

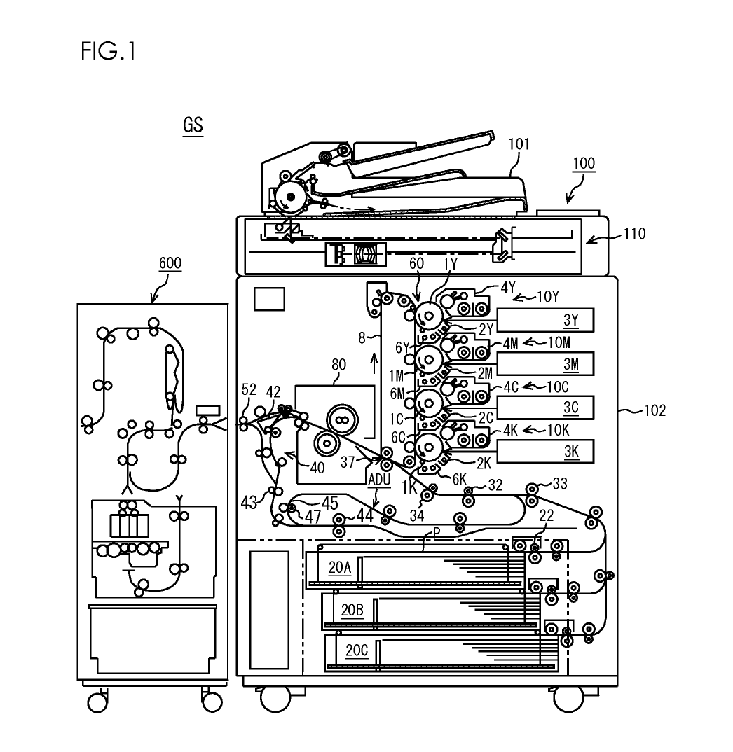

FIG. 1 shows a configuration example of an image forming system GS according to the invention. It is to be noted that a size and a ratio in each of the drawings are exaggerate for convenience of explanation and the ratio may be different from the actual one. As shown in FIG. 1, the image forming system GS according to the invention is provided with the image forming apparatus 100 and a finishing apparatus (finisher) 600.

The image forming apparatus 100 is referred to as “an image forming apparatus of tandem type”. The image forming apparatus 100 contains an automatic document feeder 101 and a main body 102 of the image forming apparatus. The automatic document feeder 101 is mounted on the main body 102. The automatic document feeder 101 feeds the sheets of paper P, which are mounted on a document mounter, to an image reading unit 110 of the main body 102 of the image forming apparatus 100 by the conveying rollers or the like.

The main body 102 of the image forming apparatus 100 contains the image reading unit 110, an image forming portion 60, an intermediate transfer belt 8, a fixing unit 80 and an automatic sheet inverse conveying unit (Auto Duplex Unit) 40, which is referred to as “ADU”.

The image-reading unit 110 irradiates light onto the document mounted on the document mounter and scans an image of the document using optics of a scan and exposure unit. The image-reading unit 110 then performs photoelectric conversion on the scanned image of the document using a charge-couple device (CCD) image sensor to obtain an image information signal. An image processing unit, not shown, performs various kinds of processing such as analog processing, analog/digital (A/D) conversion, shading compensation, compression and the like on the image information signal to output the processed signal to the image forming portion 60.

The image forming portion 60 forms an image under an electrophotographic system. The image forming portion 60 includes an image forming unit 10Y which forms a yellow (Y) image, an image forming unit 10M which forms a magenta (M) image, an image forming unit 10C which forms a cyan (C) image and an image forming unit 10K which forms a black (K) image. In this embodiment, symbols Y, M, C and K each indicating a color to be formed are respectively attached to the common functional numerals, for example, numeral 10.

The image forming unit 10Y contains a photosensitive drum 1Y, a charging portion 2Y positioned around the photosensitive drum 1Y, an exposing (writing) portion 3Y, a developing portion 4Y and a cleaning portion 6Y. The image forming unit 10M contains a photosensitive drum 1M, a charging portion 2M positioned around the photosensitive drum 1M, an exposing portion 3M, a developing portion 4M and a cleaning portion 6M. The image forming unit 10C contains a photosensitive drum 1C, a charging portion 2C positioned around the photosensitive drum 1C, an exposing portion 3C, a developing portion 4C and a cleaning portion 6C. The image forming unit 10K contains a photosensitive drum 1K, a charging portion 2K positioned around the photosensitive drum 1K, an exposing portion 3K, a developing portion 4K and a cleaning portion 6K. The photosensitive drums 1Y, 1M, 1C and 1K, the charging portions 2Y, 2M, 2C and 2K, the exposing portions 3Y, 3M, 3C and 3K, the developing portions 4Y, 4M, 4C and 4K, and the cleaning portions 6Y, 6M, 6C and 6K in the image forming units 10Y, 10M, 10C and 10K respectively have the common configuration to each other. The following will indicate them without attaching Y, M, C and K thereto apart from cases in which any differentiation is required.

The charging portions 2 charge a static charge uniformly around surfaces of the photosensitive drums 1. Each of the exposing portions 3 is composed of, for example, an LED print head (LPH) including LED array and focusing lens or a laser scan and exposure unit of polygon mirror system. The exposing portions 3 scan surfaces of the photosensitive drums 1 using laser beam based on the image information signal to form electrostatic latent images. The developing portions 4 develop the electrostatic latent images formed on the surfaces of the photosensitive drums 1 by using the toners. Accordingly, visible toner images are formed on the photosensitive drums 1.

The intermediate transfer belt 8 is stretched across plural rollers so as to be able to run around them. When driving primary transfer rollers, the intermediate transfer belt 8 runs and the toner images formed on the respective photosensitive drums 1 are transferred onto their image transfer positions of the intermediate transfer belt 8 (primary transfer).

The feeder 20 includes plural feeding trays 20A, 20B and 20C each containing sheets of paper with various kinds of sheet sizes such as A3 and A4. The feeder 20 feeds the sheet of paper P, which is conveyed from any of the feeding trays 20A, 20B and 20C using the conveying rollers 21, 22 and the like, to registration rollers 34, which are provided on a downstream side along a sheet-conveying direction, via loop forming rollers 32. It is noted that numbers of the feeding trays are not limited to three. If necessary, a single or plural large capacity feeding apparatuses which may contain large number of sheets of paper P may be connected thereto.

The registration rollers 34 contains a pair of driving roller and driven roller and register any skew of the sheet of paper P by hitting a forward end of the sheet of paper P thereto by the loop rollers 32 to create a loop.

The sheet of paper Pis conveyed to a secondary transfer portion 37 at a desired timing. The secondary transfer portion 37 transfers a color image collectively, which has been transferred to the image forming position of the intermediate transfer belt 8, on a surface of the sheet of paper P conveyed from the feeder 20 (secondary transfer). The sheet of paper P which has been secondarily transferred is conveyed to the fixing unit 80. The fixing unit 80 is provided at downstream side of the secondary transfer portion 37 along the sheet-conveying direction. The fixing unit 80 contains a pressure roller and a heating roller. The fixing unit 80 fixes the toner image on the sheet of paper P by applying pressure to the sheet of paper P onto which the secondary transfer portion 37 has transferred the toner image and/or heating the same.

A conveying route changing portion 42 for changing the conveying rote of the sheet of paper to a side of paper ejection route or a side of ADU 40 is provided at downstream side of the fixing unit 80 along the sheet-conveying direction. The conveying route changing portion 42 is composed of, for example, a solenoid, a motor and the like. The conveying route changing portion 42 switches the conveying route based on the selected printing mode (a single-side printing mode or a duplex printing mode).

The sheet of paper P which is printed during the single-side printing mode or the sheet of paper P which is printed during the duplex printing mode is conveyed to the later finishing apparatus 600 by sheet ejection rollers 52 provided at downstream side of the fixing unit 80 along the sheet-conveying direction after the sheet of paper P has been fixed in the fixing unit 80.

When the sheet of paper P is again fed to the image forming portion 60 during the duplex printing mode, the sheet of paper P, on a front surface of which the image has been formed, is conveyed to ADU 40 via the conveying route changing portion 42. The sheet of paper P conveyed to ADU 40 is conveyed to a switchback route via the conveying rollers 43 and the like. In the switchback route, the sheet of paper P is conveyed to U-turn route composed of a pair of guide plates 45 under an inverse rotation control of ADU rollers 44 with a rear end thereof facing ahead thereof. The sheet of paper P is again fed to the registration rollers 34 by the conveying rollers 47 provided at the U-turn route and the like with the sheet of paper P being reversed. Here, the pair of guide plates 45 constituting the U-turn route is configured as so to have a maximum curvature of the guide plates in the image forming apparatus 100. The sheet of paper P is subject to scratching on the guide plates 45 when the sheet of paper P is conveyed and passed through the same. On the sheet of paper P again conveyed to the registration rollers 34, the same image forming processing as that performed on the front side of the sheet of paper P is formed. The sheet of paper P, on a back surface of which the image has been formed by the image forming portion 60 is conveyed to the later finishing apparatus 600 via the conveying route changing portion 42 and the sheet ejection rollers 52 after the fixing unit 80 fixes the sheet of paper P.

The finishing apparatus 600 is positioned at downstream side of the image forming apparatus 100 along the sheet-conveying direction and connected to the image forming apparatus 100. The finishing apparatus 600 performs any finisher processing such as stable-binding processing, folding processing, Z-folding processing, and booklet trimming on the sheet of paper P fed from the image forming apparatus 100. The finishing apparatus 600 is also provided with a conveying motor, guide plates and the like, a detailed description of which will be omitted, used when the sheet of paper P is conveyed.

### [Block Configuration Example of Image Forming Apparatus]

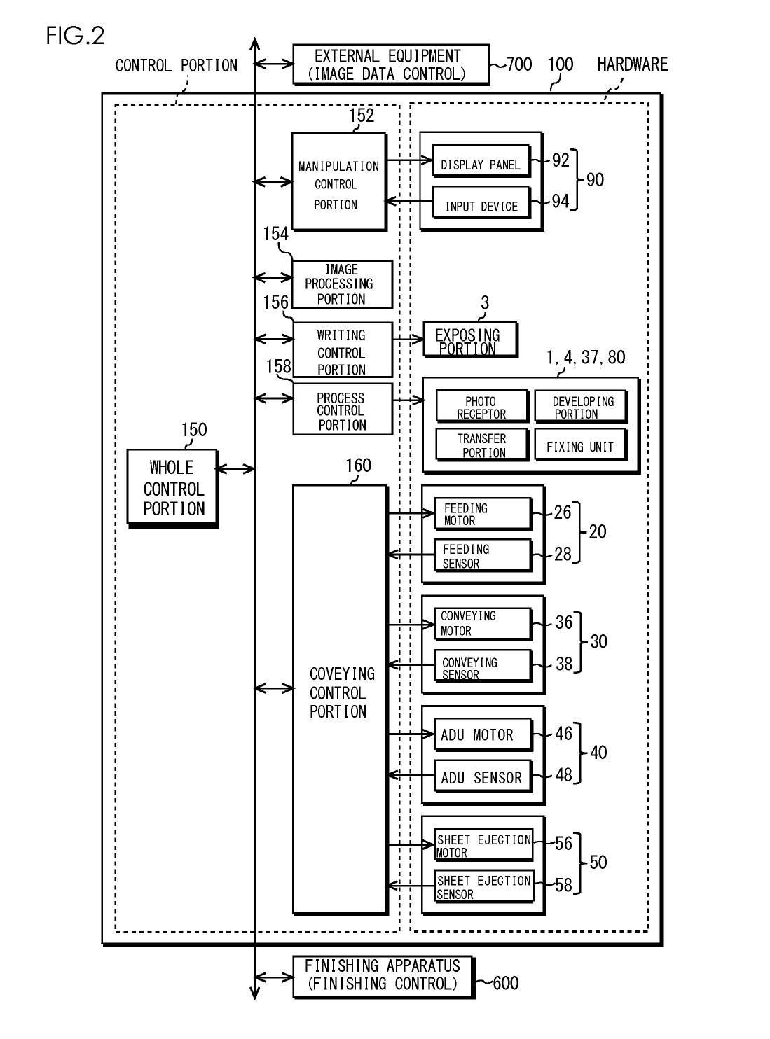

The following will describe a block configuration example of the image forming apparatus 100. FIG. 2 illustrates a block configuration example of the image forming apparatus 100. As shown in FIG. 2, the image forming apparatus 100 contains a whole control portion 150 that controls an operation of whole of the image forming apparatus 100. The whole control portion 150 includes a central processing unit (CPU), a read only memory (ROM) and a random access memory (RAM). The whole control portion 150 performs an image forming mode such as a usual single-side printing mode or a usual duplex printing mode and the conveyance checking mode by reading any programs and/or data stored in the ROM and extracting them in the RAM to execute the program. In the conveyance checking mode, any image defects are checked (detected) by stopping the sheet(s) of paper P on each of the components or at a stop position before or after each of the components.

The whole control portion 150 connects a manipulation control portion 152, an image processing portion 154, a writing control portion 156, a process control portion 158 and a conveying control portion 160, respectively. These control portions also include CPU and the like, and they are linked to the whole control portion 150 to control each component thereof based on any instructions supplied from the whole control portion 150.

The manipulation control portion 152 controls an operation of a manipulation panel 90. The manipulation panel 90 is attached to an upper portion of a main body of the image forming apparatus. The manipulation panel 90, which is a setting portion, is composed of a display panel 92 and an input device 94. The display panel 92 is a touch panel combining, for example, a position detection device with a display device. The display panel 92 displays, for example, a menu screen 200, an automatic/manual selection screen 300, an automatic setting screen 400, a manual setting screen 500, which will be described later. The input device 94 is provided on a surrounding area of the display panel 92 and is composed of plural manipulation buttons. As the manipulation buttons, for example, a start button for copy, numeral buttons and the like are used.

The image processing portion 154 performs any image processing such as analog processing, analog/digital (AD) conversion processing, shading processing, image compression processing and/or the like on the image data of the sheet of paper P read by the image reading portion 110. The writing control portion 156 controls an exposing portion 3 and the like. The exposing portion 3 is composed of LED print head (LPH) having an LED head and focusing lens and a laser exposing and scanning device of polygon mirror type. The process control portion 158 controls operations of the photosensitive drum 1, a developing portion 4, the secondary transfer portion 37, the fixing unit 80 and the like.

The conveying control portion 160 controls operations of the feeding portion 20, the conveying portion 30, ADU 40, and sheet ejection portion 50. The feeding portion 20 contains a feeding motor 26 and a feeding sensor 28. The feeding sensor 28 is composed of, for example, a sensor of reflection type or a sensor of transmission type, and the like. The feeding sensor 28 is positioned near the feeding rollers 22. The feeding sensor 28 detects the sheet of paper P conveyed from any of the feeding trays 20A, 20B and 20C and supplies a sheet detection signal based on the sheet detection to the whole control portion 150 through the conveying control portion 160.

The feeding motor 26 is composed of, for example, a stepping motor or the like. The feeding motor 26 starts or stops based on an instruction value (driving signal) supplied from the conveying control portion 160 to control rotation operation of the feeding rollers 22. The conveying control portion 160 stops the feeding motor 26 after predetermined counts according to the detection signal supplied from the feeding sensor 28 as a trigger thereof when selecting the conveyance checking mode to stop the sheet of paper P at a stop position, for example, a previously set stop position before or after the component or a stop position optionally set by a user or the like. It is to be noted that the feeding motor 26 constitutes a sheet conveying portion.

The conveying portion 30 contains a conveying motor 36 and a conveying sensor 38. The conveying sensor 38 is composed of, for example, a sensor of reflection type or a sensor of transmission type, and the like. The conveying sensor 38 is positioned near the conveying rollers 33. Of course, the conveying sensor 38 may be positioned near other rollers such as the registration rollers 34. The conveying sensor 38 detects the sheet of paper P conveyed to the conveying rollers 33 and supplies a detection signal based on the sheet detection to the whole control portion 150 through the conveying control portion 160.

The conveying motor 36 is composed of, for example, a stepping motor or the like. The conveying motor 36 starts or stops based on an instruction value supplied from the conveying control portion 160 to control rotation operation of the conveying rollers 33. The conveying control portion 160 stops the conveying motor 36 after predetermined counts according to the detection signal supplied from the conveying sensor 38 as a trigger thereof when selecting the conveyance checking mode to stop the sheet of paper P at a stop position, for example, a previously set stop position before or after the component or a stop position optionally set by a user or the like. It is to be noted that the conveying motor 36 constitutes a sheet conveying portion.

ADU 40 contains an ADU motor 46 and an ADU sensor 48. The ADU sensor 48 is composed of, for example, a sensor of reflection type or a sensor of transmission type, and the like. The ADU sensor 48 is positioned near the ADU rollers 44. The ADU sensor 48 detects the sheet of paper P conveyed to the ADU rollers 44 and supplies a detection signal based on the sheet detection to the whole control portion 150 through the conveying control portion 160.

The ADU motor 46 is composed of, for example, a stepping motor or the like. The ADU motor 46 starts or stops based on an instruction value supplied from the conveying control portion 160 to control rotation operation of the ADU rollers 44. The conveying control portion 160 stops the ADU motor 46 after predetermined counts according to the detection signal supplied from the ADU sensor 48 as a trigger thereof when selecting the conveyance checking mode to stop the sheet of paper Pat a stop position, for example, a previously set stop position before or after the component or a stop position optionally set by a user or the like. It is to be noted that the ADU motor 46 constitutes a sheet conveying portion.

The sheet ejection portion 50 contains a sheet ejection motor 56 and a sheet ejection sensor 58. The sheet ejection sensor 50 is composed of, for example, a sensor of reflection type or a sensor of transmission type, and the like. The sheet ejection sensor 58 is positioned near the sheet ejection rollers 52. The sheet ejection sensor 58 detects the sheet of paper P conveyed to the sheet ejection rollers 52 and supplies a detection signal based on the sheet detection to the whole control portion 150 through the conveying control portion 160.

The sheet ejection motor 56 is composed of, for example, a stepping motor or the like. The sheet ejection motor 56 starts or stops based on an instruction value supplied from the conveying control portion 160 to control rotation operation of the sheet ejection rollers 52. The conveying control portion 160 stops the sheet ejection motor 56 after predetermined counts according to the detection signal supplied from the sheet ejection sensor 58 as a trigger thereof when selecting the conveyance checking mode to stop the sheet of paper P at a stop position, for example, a previously set stop position before or after the component or a stop position optionally set by a user or the like. It is to be noted that the sheet ejection motor 56 constitutes a sheet conveying portion

When stopping the sheet of paper P at the guide plates 45 or the like, the conveying control portion 160 stops driving the conveying motor based on the detection result of the sensor provided at the surrounding of the guide palates 45. Accordingly, the conveying control portion 160 can stop the conveyance of sheet of paper P at a stop position before or after the guide plates 45 or in a route of the guide plates 45.

To the image forming apparatus 100, external equipment 700 is connected via an interface. The external equipment 700 is, for example, a personal computer or the like. The external equipment 700 sends a printing job including image data and the like to the image forming apparatus 100. The finishing apparatus 600 connects the whole control portion 150 of the image forming apparatus 100 and links the image forming apparatus 100 to perform a predetermined finishing control based on the instruction from the whole control portion 150.

### [Configuration Example of Menu Screen]

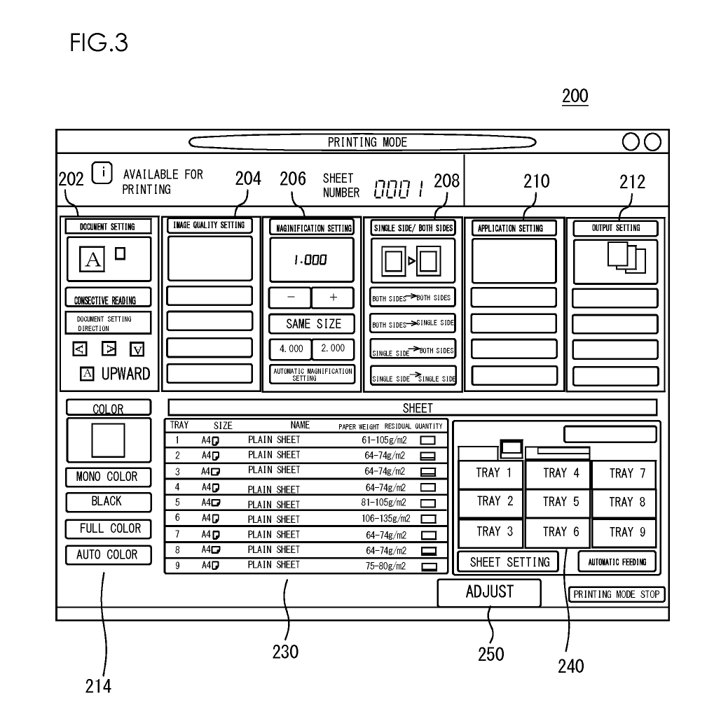

The following will describe a configuration example of the menu screen 200 displayed on the display panel 92. FIG. 3 shows the configuration example of the menu screen 200. The display panel 92 has a touch panel function, as described above, and allows a function corresponding to a button pushed down by the user or the like to be performed.

The menu screen 200 shown in FIG. 3 is an initial (basic) screen represented when power of the image forming apparatus 100 is on or the image forming apparatus 100 is returned from its sleep mode or its low power mode. The menu screen 200 represents plural basic setting items. Particularly, on an upper column of the displayed screen, the menu screen 200 represents a document setting portion 202, an image quality setting portion 204, a magnification setting portion 206, single side/both sides setting portion 208, an application setting portion 210 and an output setting portion 212 in order from the left side of the screen.

On a lower column of the displayed screen, the menu screen 200 represents a color setting portion 214, a feeding tray display portion 230 for displaying various kinds of information about the sheet of paper presently set in the feeding tray of the image forming apparatus 100, and a feeding tray selecting portion 240 for selecting the feeding tray. Below the feeding tray selecting portion 240, the menu screen 200 represents an adjustment button 250 for selecting a conveying stop mode in which it is analyzed where the image defects such as image cracks, a roller trace and/or a scratch occur. By selecting the adjustment button 250, the image forming apparatus 100 changes its mode from a normal image forming mode to the conveying stop mode. In this moment, the display panel 92 changes its screen representation to the automatic/manual selection screen 300.

### [Configuration Example of Automatic/Manual Selection Screen]

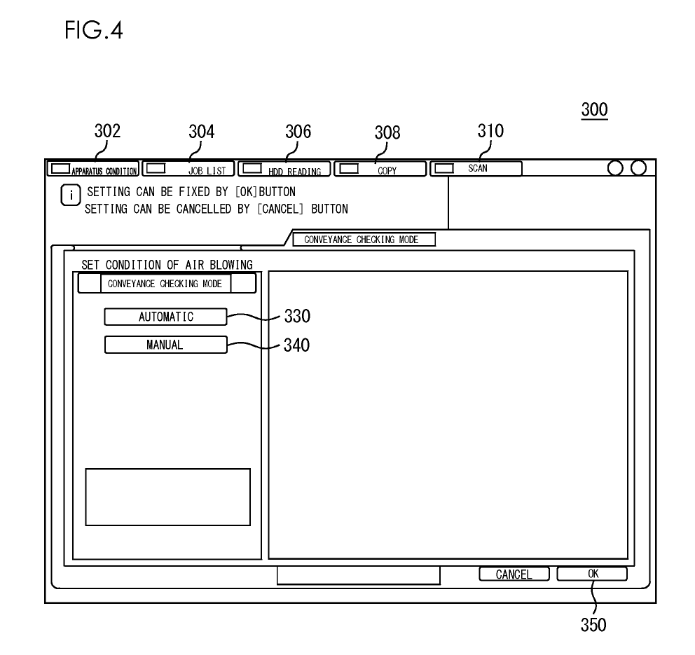

FIG. 4 shows a configuration example of the automatic/manual selection screen 300. As shown in FIG. 4, when selecting the adjustment button 250 on the menu screen 200, the display panel 92 changes its screen representation from the menu screen 200 to the automatic/manual selection screen 300. On an upper portion of the automatic/manual selection screen 300, an apparatus condition icon 302, a job list icon 304, an HDD reading icon 306, a copy icon 308 and a scan icon 310 are represented in order from the left side of the screen. These icons indicate functions of the image forming apparatus 100.

On a left side sub-screen from a middle of the automatic/manual selection screen 300, an automatic selection button 330 for selecting when a stop condition of the sheet of paper P is automatically set and a manual selection button 340 for selecting when a stop condition of the sheet of paper P is manually set are represented. Here, the automatic setting is the setting in which a stop position of the sheet of paper P, conveying speed thereof and/or the like are previously set by default in the conveying stop mode. In the automatic setting, as the sheet conditions such as a species of the sheet of paper, a feeding tray, a size of the sheet of paper and conveying speed thereof, the most recent sheet conditions, which are set (just) before a test printing operation has been carried out, are basically applied. The manual setting is the setting in which a stop position of the sheet of paper P, a species of the sheet of paper, a feeding tray, a size of the sheet of paper, conveying speed thereof and/or the like are voluntarily (freely) set by the user or the like. When the OK button 350 is selected after the automatic selection button 330 is selected, the display panel 92 changes its screen representation to the automatic setting screen 400. On the other hand, when the OK button 350 is selected after the manual selection button 340 is selected, the display panel 92 changes its screen representation to the manual setting screen 500.

### [Configuration Example of Automatic Setting Screen]

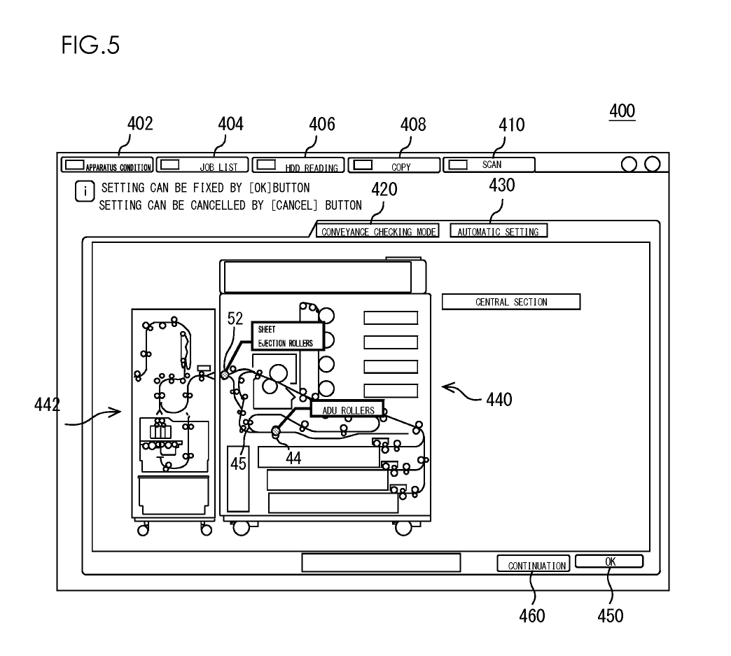

FIG. 5 shows a configuration example of the automatic setting screen 400. As shown in FIG. 5, when selecting the automatic selection button 330 on the automatic/manual selection screen 300, the display panel 92 changes its screen representation from the automatic/manual selection screen 300 to the automatic setting screen 400. On an upper portion of the automatic setting screen 400, an apparatus condition icon 402, a job list icon 404, an HDD reading icon 406, a copy icon 408 and a scan icon 410 are represented in order from the left side of the screen. These icons indicate functions of the image forming apparatus 100. Below these icons, a conveyance checking mode representation 420 for indicating a presently selected mode and an automatic setting representation 430 are represented.

On almost a middle of the automatic setting screen 400, reduced screens 440, 442 for schematically illustrating sections of the image forming apparatus 100 and the finishing apparatus 600 are respectively represented. The reduced screens 440, 442 are configured to select conveying rollers or guide plates, base on which the image defects occur, and to allow for stopping the sheet of paper P on the selected component or a stop position before or after the selected component. For example, the reduced screens 440, 442 are configured to select any of the sheet ejection rollers 52, the ADU rollers 44, the guide plates 45 having the maximum curvature of the ADU 40 and the like. When the user or the like wants to stop the sheets of paper P on set positions of plural components, the reduced screens 440, 442 are configured to select the plural components. This allows numbers of sheets of paper P corresponding to numbers of the selected components to stop at the stop positions of the selected components.

On a lower portion of the automatic setting screen 400, an OK button 450 to be selected when the conveying stop mode starts after the setting of the stop condition is completed and a continuation button 460 to be selected when one component is selected and another component is then selected are represented.

### [Configuration Example of Manual Setting Screen]

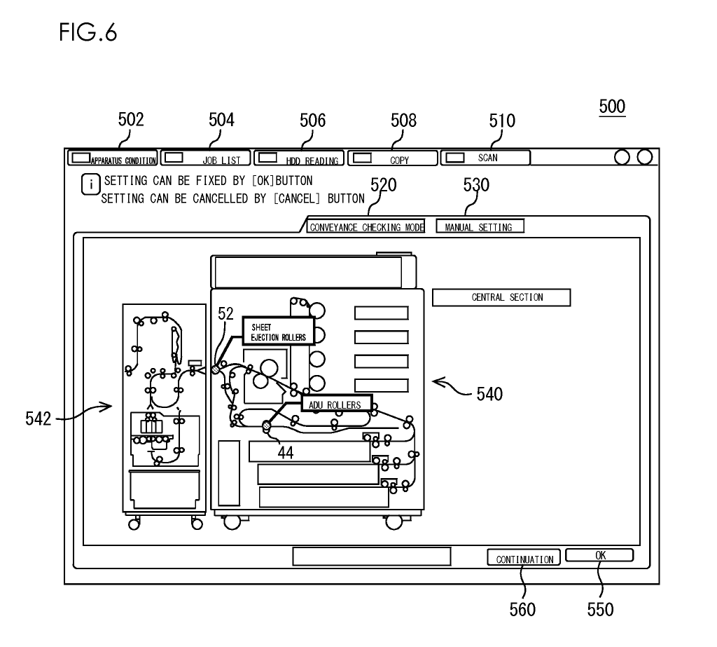

FIG. 6 shows a configuration example of the manual setting screen 500. As shown in FIG. 6, when selecting the manual selection button 340 on the automatic/manual selection screen 300, the display panel 92 changes its screen representation from the automatic/manual selection screen 300 to the manual setting screen 500. The manual setting screen 500 has a configuration almost identical to that of the automatic setting screen 400 except for the manual setting representation 530 as a representation for indicating to the presently selected mode, which is represented below the icons. Accordingly, the following will describe the manual setting screen 500 as brief explanation thereof. On almost a middle of the manual setting screen 500, reduced screens 540, 542 for schematically illustrating sections of the image forming apparatus 100 and the finishing apparatus 600 are respectively represented. The reduced screens 540, 542 are configured to select conveying rollers or guide plates, base on which the image defects occur. In the manual setting screen 500, a selection screen for selecting the feeding tray, a species of sheet of paper, a size thereof may be also represented in order to select the sheet of paper P to be selected in the conveyance checking mode. Further, in the manual setting screen 500, a manipulation screen for selecting the conveying speed of the sheet of paper may be also represented in order to set conveying speed of the sheet of paper, in the conveyance checking mode, which is different from the conveying speed of the sheet of paper in the normal image forming mode to form an image on the sheet of paper P.

### [Operation Example of Image Forming Apparatus]

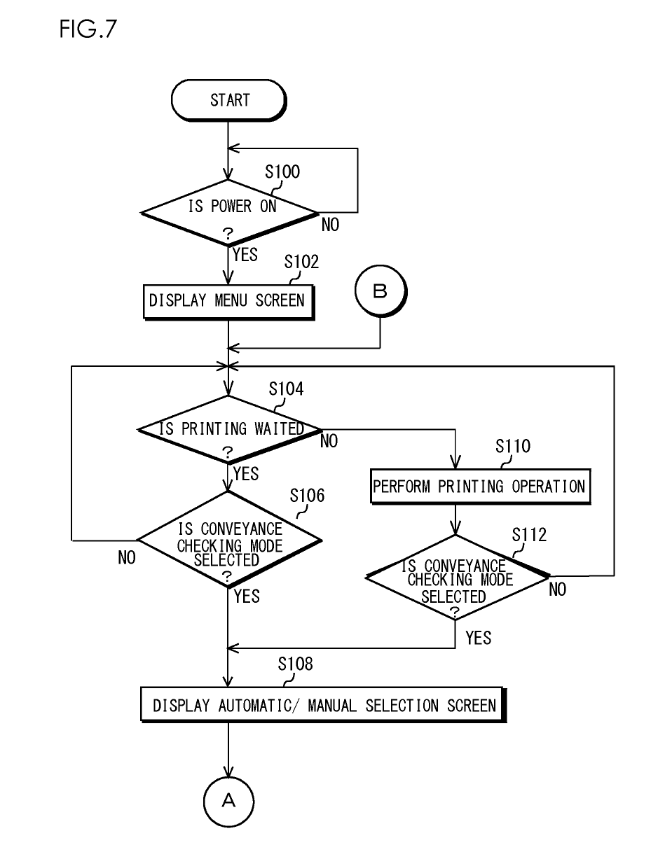

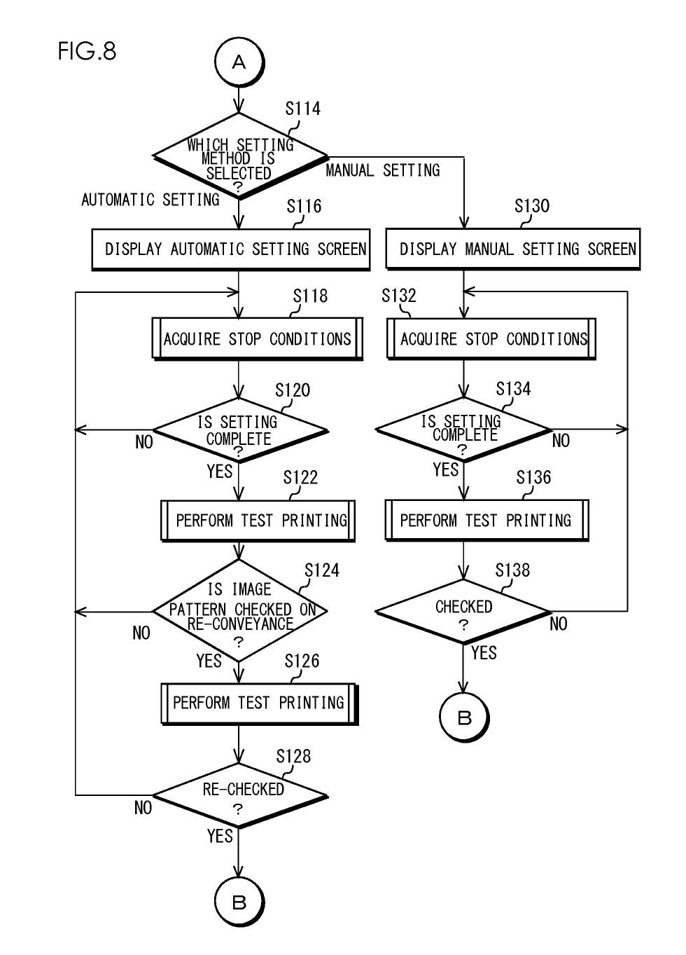

The following will describe an operation example of the whole control portion 150 of the image forming apparatus 100 during the conveyance checking mode with reference to FIGS. 3 through 13. FIGS. 7 and 8 show an operation example of the whole control portion 150 of the image forming apparatus 100 when selecting the conveyance checking mode. Hereinafter, an operation example of the whole control portion 150 will be described when checking whether or not the image defects occur in the image forming apparatus 100.

As shown in FIG. 7, at a step 5100, the whole control portion 150 determines whether or not the user or the like turns power of the image forming apparatus 100 on or whether or not the image forming apparatus 100 is returned from its sleep mode (low power mode). On the following description, a case where the user or the like turns power of the image forming apparatus 100 on will be described. If the whole control portion 150 determines that the user or the like turns power of the image forming apparatus 100 on, then the whole control portion 150 goes to a step 5102. If the whole control portion 150 determines that power of the image forming apparatus 100 remains off at the step 5100, then the whole control portion 150 keeps watch over the power of the image forming apparatus 100 until the power is on.

At the step S102, the whole control portion 150 controls the display panel 92 to display the menu screen 200 shown in FIG. 3 thereon when the power of the image forming apparatus 100 becomes on. After the menu screen 200 is displayed on the display panel 92, the whole control portion 150 goes to a step S104.

At the step S104, the whole control portion 150 determines whether or not the printing operation is selected after the image forming conditions such as selection of feeding tray and the like are finally set on the menu screen 200. Whether or not the printing operation is selected is determined based on whether or not the start button of the input device 94 is pushed down by the user or the like. If the whole control portion 150 determines that the printing operation is not selected, namely, the image forming apparatus 100 is in printing-waiting condition, then the whole control portion 150 goes to a step S106. On the other hand, if the whole control portion 150 determines that the printing operation is selected, namely, the image forming apparatus 100 is not in printing-waiting condition, then the whole control portion 150 goes to a step S110.

At the step S106, the whole control portion 150 determines whether or not the conveyance checking mode is selected on the menu screen 200. Particularly, whole control portion 150 determines whether or not the adjustment button 250 represented on the menu screen 200 is pushed down by the user or the like. If the whole control portion 150 determines that the conveyance checking mode is selected on the menu screen 200, then the whole control portion 150 goes to a step S108. On the other hand, if the whole control portion 150 determines that the conveyance checking mode is not selected on the menu screen 200, then the whole control portion 150 goes back to the step S104 where the whole control portion 150 keeps watching whether or not the printing operation is selected.

At the step S110, the whole control portion 150 performs the printing operation based on the image forming conditions set on the menu screen 200. On the printing operation, operations of the image forming portion 60 and the like are controlled as described above to form a desired image on the sheet of paper P.

At the step S112, the whole control portion 150 determines whether or not the adjustment button 250 is selected on the menu screen 200 during the printing operation. In other words, the whole control portion 150 determines whether or not the conveyance checking mode is selected during the printing operation to check any image defects on the image formed on the sheet of paper P. If the whole control portion 150 determines that the conveyance checking mode is selected, then the whole control portion 150 goes to the step S108. On the other hand, the whole control portion 150 determines that the conveyance checking mode is not selected, then the whole control portion 150 goes back to the step S104 where the whole control portion 150 keeps performing the present printing operation and keeps determining whether or not the next printing operation is selected.

At the step S108, the whole control portion 150 switches the operation mode from the normal image forming mode to the conveyance checking mode when the conveyance checking mode is selected. The whole control portion 150 switches a display screen of the display panel 92 from the menu screen 200 to the automatic/manual selection screen 300 shown in FIG. 4 for the conveyance checking mode. If the display panel 92 displays the automatic/manual selection screen 300, then the whole control portion 150 goes to a step S114 shown in FIG. 8.

At the step S114, as shown in FIG. 8, the whole control portion 150 determines which of the automatic selection button 330 and the manual selection button 340 is selected by the user or the like on the automatic/manual selection screen 300. If the whole control portion 150 determines that the automatic selection button 330 is selected on the automatic/manual selection screen 300, then the whole control portion 150 goes to a step S116. On the other hand, if the whole control portion 150 determines that the manual selection button 340 is selected, then the whole control portion 150 goes to a step S130.

First, a case in which the automatic selection button 330 is selected will be described. When the automatic selection button 330 is selected on the automatic/manual selection screen 300, at a step S116, the whole control portion 150 switches a display screen of the display panel 92 from the automatic/manual selection screen 300 to the automatic setting screen 400 shown in FIG. 5. If the display panel 92 displays the automatic setting screen 400, then the whole control portion 150 goes to a step S118.

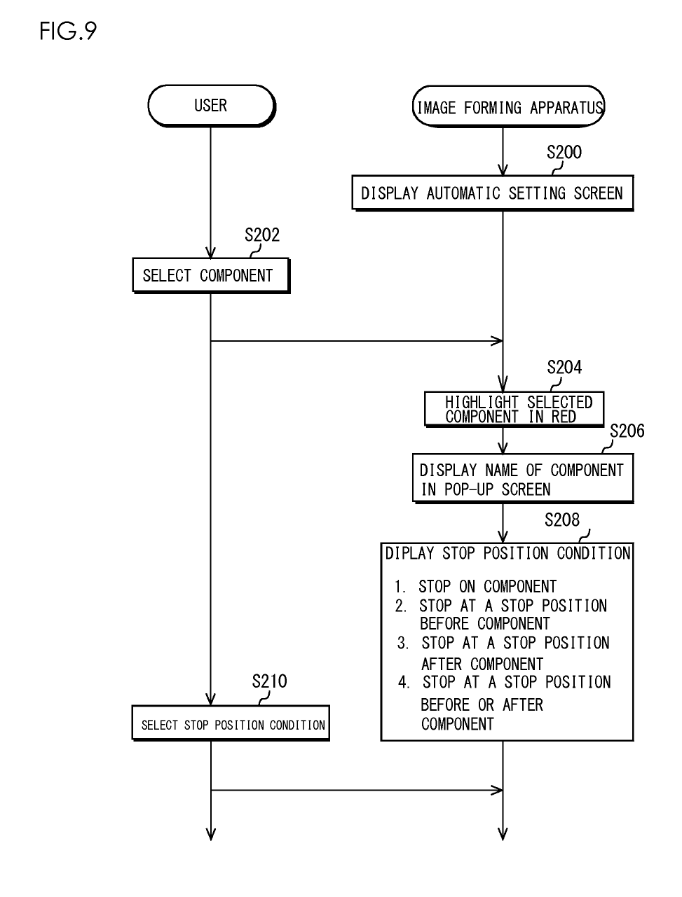

When the user or the like sets stop condition information such as target component, stop position conditions and successive operation on the automatic setting screen 400, at the step S118, the whole control portion 150 acquires these pieces of stop condition information from the input device 94. FIG. 9 shows operation examples of the whole control portion 150 in the image forming apparatus 100 and the user when setting the stop conditions on the automatic setting screen 400. When the automatic selection button 330 is selected on the automatic/manual selection screen 300, at a step S200, the whole control portion 150 switches a display screen of the display panel 92 to the automatic setting screen 400.

At a step S202, when the user or the like selects a desired component on the reduced screen 440 of the image forming apparatus 100 in the automatic setting screen 400, the display panel 92 supplies a selection signal corresponding to the selected component to the whole control portion 150. In this embodiment, for example, it is estimated that the sheet ejection rollers 52 and the ADU rollers 44 are selected.

At a step S204, the whole control portion 150 highlights the component (s) selected by the user or the like on the reduced screen 440 based on the selection signal supplied from the display panel 92. For example, when the user or the like selects the sheet ejection rollers 52 on the reduced screen 440 of the image forming apparatus 100 in the automatic setting screen 400, as shown in FIG. 5, the whole control portion 150 highlights the sheet ejection rollers 52 selected by the user or the like on the reduced screen 440 in, for example, red (shown in FIG. 5 in black).

At a step S206, the whole control portion 150 displays a name of the component (s) selected by the user or the like on the reduced screen 440 in addition to the highlight of the selected component(s). For example, when the user or the like selects the sheet ejection rollers 52 in the reduced screen 440 of the image forming apparatus 100 on the automatic setting screen 400, as shown in FIG. 5, the whole control portion 150 displays a name of the component, “Sheet Ejection Rollers” near the sheet ejection rollers 52 selected by the user or the like on the reduced screen 440. In this moment, component identification number, for example, part number of the component may be concurrently displayed together with the name of component. This enables the user or the like to order this displayed component immediately based on the name of component, the part number and/or the like when the image defects are based on the selected component. It is thus possible to solve the image defects rapidly. Further, when there are any spare components, the user or the like can exchange the defected component for the spare component rapidly.

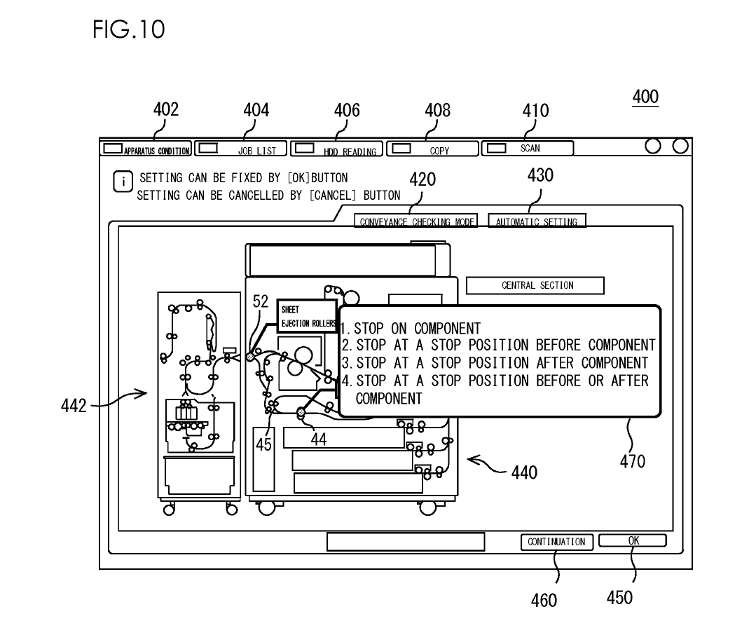

Next, at a step S208, the whole control portion 150 represents a stop-position-condition-setting screen 470 for selecting the stop position condition of the selected component in a pop-up screen on the automatic setting screen 400, as shown in FIG. 10, when a desired component is selected on the automatic setting screen 400. For example, as contents of the stop-position-condition-setting screen 470, the four following items are represented:
1. Stop on the component;
2. Stop at a stop position before the component;
3. Stop at a stop position after the component; and
4. Stop at a stop position before or after the component.

At a step S210, the display panel 92 supplies to the whole control portion 150 any selection information corresponding to the selected stop position condition when the user or the like selects (or pushes down) the desired stop position on the stop-position-condition-setting screen 470 in a pop-up screen. The whole control portion 150 stores this selection information on a memory portion, not shown. The whole control portion 150 reads the selection information out of the memory portion during the test printing operation and stops conveying the sheet of paper P at a desired stop position of the selected component based on the selection information thus read. When the selection of stop position is complete, the whole control portion 150 goes to a step S120 shown in FIG. 8.

At the step S120, the whole control portion 150 determines whether or not setting of the stop condition such as a specification of the component, the stop position condition of the component and the like is complete on the automatic setting screen 400. When an OK button 450 is selected on the automatic setting screen 400, the whole control portion 150 determines that the setting of the stop condition of the sheet of paper P is complete and goes to a step S122. On the other hand, when a continuation button 460 is selected on the automatic setting screen 400, the whole control portion 150 determines that the setting of the stop condition of the sheet of paper P is incomplete and goes back to the step S118 where it waits until the setting of the stop condition of the sheet of paper P is complete. For example, a case where another component is selected is illustrated.

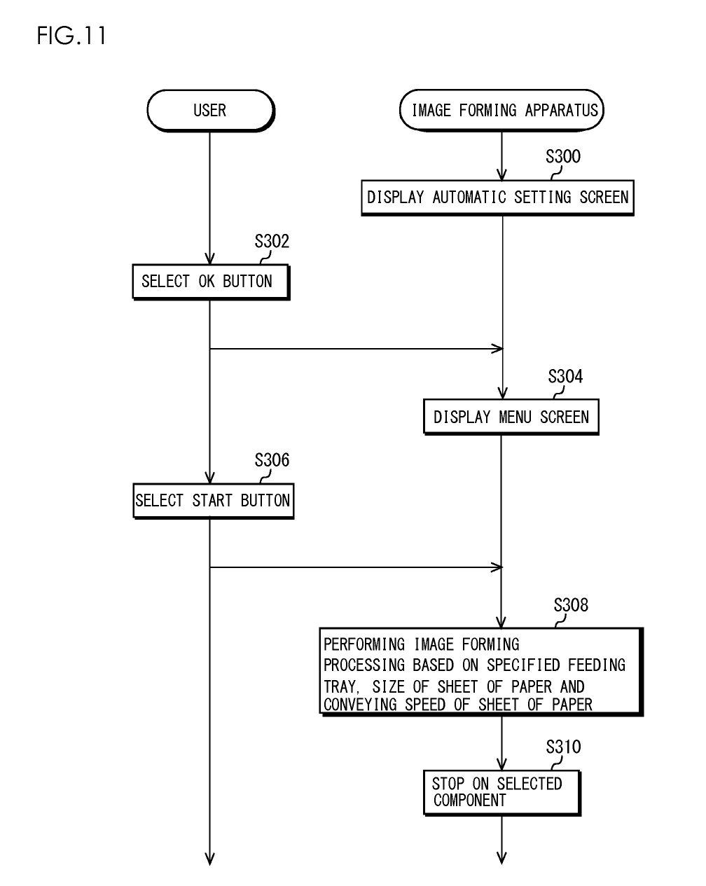

At the step S122, the whole control portion 150 performs a test printing operation based on the setting condition selected on the automatic setting screen 400. FIG. 11 shows operation examples of the whole control portion 150 in the image forming apparatus 100 and the user during the test printing operation. As shown in FIG. 11, at a step S300, the display panel 92 displays the automatic setting screen 400. At a step S302, when the user or the like selects the OK button 450 on the automatic setting screen 400, the display panel 92 supplies a manipulation signal corresponding to the selected OK button 450 to the whole control portion 150.

At a step S304, the whole control portion 150 switches a screen of the display panel 92 from the automatic setting screen 400 to the menu screen 200 based on the manipulation signal supplied from the display panel 92. On the menu screen 200, the terms, for example, “available for printing” as shown in FIG. 3 are represented.

At a step S306, when the user or the like pushes down a start button, not shown, of the input device 94 to start the test printing operation, the display panel 92 supplies a manipulation signal corresponding to the push-down of the start button to the whole control portion 150.

At a step S308, the whole control portion 150 performs the test printing operation in the conveying stop mode based on the selection signal corresponding to the start button. Particularly, image forming control, process control and sheet-conveying control are performed under the sheet condition (the most recent printing condition) such as a species of the sheet of paper, a feeding tray, a size of the sheet of paper, conveying speed thereof and/or the like, which is set just before a test printing operation has been started. This enables a period of setting time for selecting the sheet condition such as the feeding tray to be shortened. Of course, the sheet condition such as the species of the sheet of paper, the feeding tray, the size of the sheet of paper, the conveying speed thereof and/or the like may be set on the automatic setting screen 400. It is desirable that an image pattern formed on the sheet of paper P in this test printing mode is a pattern in which the defect is visible. Preferably, a pattern printed over the sheet of paper in one color is desirable.

At a step S310, the whole control portion 150 controls driving of the motor corresponding to the selected component to stop the sheet of paper P at a set position of the component selected by the user or the like on the automatic setting screen 400. It is to be noted that the whole control portion 150 may represent on the menu screen 200 or the manual setting screen 500 any manipulation screen that is able to move the sheet of paper P by a predetermined amount of movement from the stop position thereof after the sheet P stops at the set position of the selected component. The whole control portion 150 controls driving of the sheet-conveying portion such as the motor to move the sheet of paper P by an amount of movement set by the user or the like on this manipulation screen. This enables a fine positional adjustment of the sheet of paper P to the selected component to be made. When the test printing operation finishes, the whole control portion 150 goes to a step S124 shown in FIG. 8.

At the step S124, the user or the like removes the sheet of paper P, which stops at the set position of the selected component, from the image forming apparatus 100 and checks the image pattern formed on the sheet of paper P. When the component is rollers such as the sheet ejection rollers 52, the user or the like releases the rollers to remove the sheet of paper P from the image forming apparatus 100. For example, the user or the like checks whether or not the component corresponding to the stop position forms any image defects such as image cracks, a roller trace and/or a scratch on the image pattern of the sheet of paper P. Namely, the user or the like checks whether or not the image defects occur in this component. In this moment, if the user or the like determines that the image defects occur based on the component corresponding to the stop position, he orders an article according to the article name or article identification number such as article number represented on the screen. If there are any spare components therefor, he exchanges this component for the spare component.

At a step S126, the whole control portion 150 again performs the test printing operation shown in FIG. 11. At a step S128, the user or the like again checks the image pattern formed on the sheet of paper P which stops at the set position of the component specified by the action of the test printing operation. If he again checks the image pattern, then the whole control portion 150 goes back to the step S104 where it determines whether or not next printing operation is input. Further, if the conveyance checking mode is selected during the printing operation, then the whole control portion 150 again starts performing processing during the printing operation. On the other hand, if the conveyance checking mode is continued, then the whole control portion 150 goes back to the step S118 where the above-mentioned stop condition of the sheet of paper P or the like is set.

Next, a case where the manual selection button 340 is selected on the automatic/manual selection screen 300 will be described. When the manual selection button 340 is selected on the automatic/manual selection screen 300, at a step S130, the whole control portion 150 switches a display screen of the display panel 92 from the automatic/manual selection screen 300 to the manual setting screen 500 shown in FIG. 6. If the display panel 92 displays the manual setting screen 500, then the whole control portion 150 goes to a step S132.

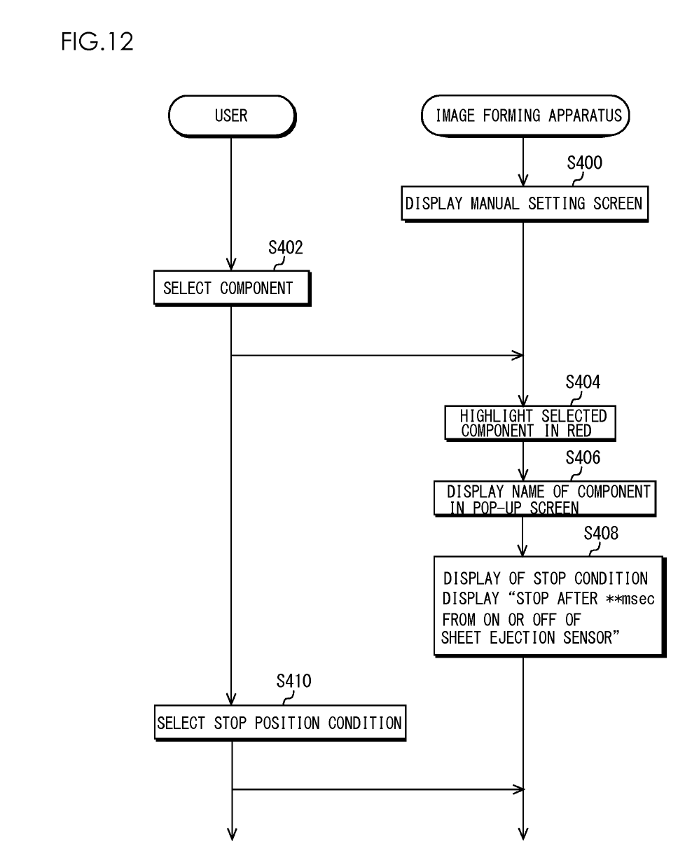

When the user or the like sets stop condition information such as target component, stop position conditions and successive operation on the manual setting screen 500, at the step S132, the whole control portion 150 acquires these pieces of stop condition information from the input device 94. FIG. 12 shows operation examples of the whole control portion 150 in the image forming apparatus 100 and the user when setting the stop conditions on the manual setting screen 500. When the manual selection button 340 is selected by the user or the like on the automatic/manual selection screen 300, at a step S400, the whole control portion 150 switches a display screen of the display panel 92 to the manual setting screen 500.

At a step S402, when the user or the like selects a desired component on the reduced screen 540 of the image forming apparatus 100 in the manual setting screen 500, the display panel 92 supplies a selection signal corresponding to the selected component to the whole control portion 150.

At a step S404, the whole control portion 150 highlights the component (s) selected by the user or the like on the reduced screen 540 based on the selection signal supplied from the display panel 92. For example, when the user or the like selects the sheet ejection rollers 52 on the reduced screen 540 of the image forming apparatus 100 in the manual setting screen 500, as shown in FIG. 6, the whole control portion 150 highlights the sheet ejection rollers 52 selected by the user or the like on the reduced screen 540 in, for example, red (shown in FIG. 5 in black).

At a step S406, the whole control portion 150 displays a name of the component selected by the user or the like on the reduced screen 540 in addition to the highlight of the selected component. For example, when the user or the like selects the sheet ejection rollers 52 in the reduced screen 540 of the image forming apparatus 100 on the manual setting screen 500, as shown in FIG. 6, the whole control portion 150 displays a name of the component, “Sheet Ejection Rollers” near the sheet ejection rollers 52 selected by the user or the like on the reduced screen 540. In this moment, component identification number such as part number of the component or the like may be concurrently displayed together with the name of component.

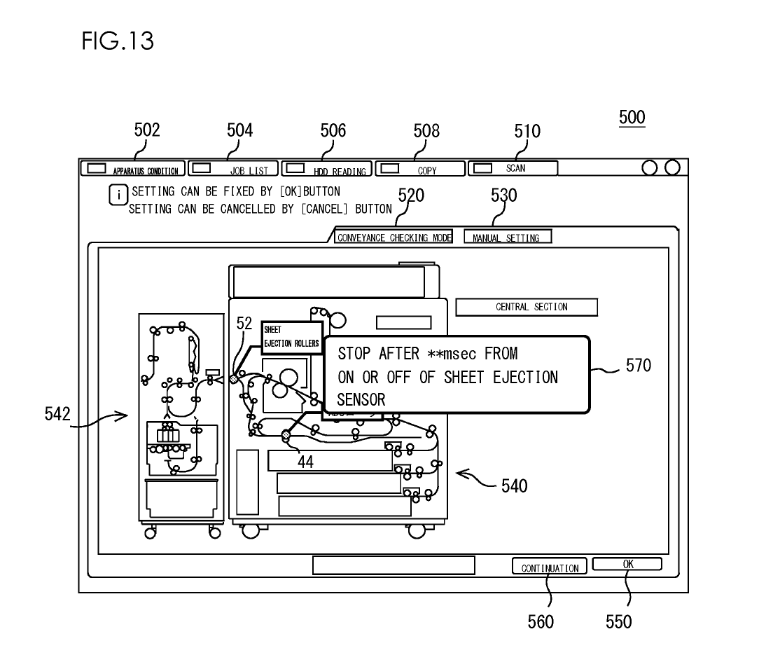

Next, at a step S408, the whole control portion 150 represents a stop-position-condition-setting screen 570 for selecting the stop position condition of the selected component in a pop-up screen on the manual setting screen 500, as shown in FIG. 13, when a desired component is selected on the manual setting screen 500. For example, when the sheet ejection rollers are selected as the stop position, the sheet ejection sensor 50 is used as a trigger of the stop so that as contents of the stop-position-condition-setting screen 570, the terms, “Stop after**msec from ON or Off of sheet ejection sensor” are represented.

In this moment, any selection screen for selecting a species of the sheet of paper, a feeding tray, a size of the sheet of paper and/or conveying speed thereof may be represented on the manual setting screen 500. This is because there may be difference in the conveying routes according to the feeding trays so that there is a case it may check whether or not any failure such as an edge folding of the sheet of paper P occurs for every feed tray. This is also because there may be different cases where an occurrence of roller marker is necessary or not based on the species of the sheet of paper and any difference in the conveying speeds of the sheets of paper so that in each case, these conditions may be compared to check them.

At a step S410, the display panel 92 supplies to the whole control portion 150 any selection information corresponding to the input stop position when the user or the like inputs a numerical value as the stop position condition on the top-position-condition-setting screen 570 in a pop-up screen. Such an input operation may be performed by the numeral buttons of the input device 94. The whole control portion 150 stores this selection information on, for example, a memory portion. The whole control portion 150 reads the selection information out of the memory portion during the test printing operation and stops conveying the sheet of paper P at a desired stop position of the selected component based on the selection information thus read. When the selection of stop position is complete, the whole control portion 150 goes to a step 5134 shown in FIG. 8.

At the step S134, the whole control portion 150 determines whether or not setting of the stop condition such as a specification of the component, the stop position condition of the component and the like is complete on the manual setting screen 500. When an OK button 550 is selected on the manual setting screen 500, the whole control portion 150 determines that the setting of the stop condition of the sheet of paper P is complete and goes to a step S136. On the other hand, when a continuation button 560 is selected on the manual setting screen 500, the whole control portion 150 determines that the setting of the stop condition of the sheet of paper P is incomplete and goes back to the step S132 where it waits until the setting of the stop condition of the sheet of paper P is complete.

At the step S136, the whole control portion 150 performs a test printing operation based on the setting condition selected on the manual setting screen 500. Such a test printing operation is identical to that of the automatic setting (see FIG. 11), a detailed explanation of which will be omitted.

At a step S138, the user or the like takes the sheet of paper P, which stops at the set position of the selected component, out of the image forming apparatus 100 and checks the image pattern formed on the sheet of paper P. For example, the user or the like checks whether or not the component corresponding to the stop position forms any image defect such as image cracks, a roller trace and/or a scratch on the image pattern of the sheet of paper P. Namely, the user or the like checks whether or not the image defect occurs in this component. In this moment, if the user or the like determines that the image defect occurs based on the component corresponding to the stop position, he orders an article according to the article name or article identification number such as article number represented on a screen. If there are any spare components therefor, he exchanges this component for the scare component.

If the check is complete, then the whole control portion 150 goes back to the step S104 shown in FIG. 7 where it determines whether or not next printing operation is input. If the user or the like selects the conveyance checking mode during the printing operation, then the whole control portion 150 again starts the processing during the printing operation. On the other hand, if the conveyance checking mode is continued, then the whole control portion 150 goes back to the step S132 where the stop condition of the sheet of paper P or the like is again set. In the conveyance checking mode, such a series of operations is repeated.

As described above, according to the embodiments, in the conveyance checking mode, the sheet of paper P stops on the component selected on the automatic setting screen 400 or the like or at a stop position before or after the component and the user or the like removes the stopped sheet of paper P from the stop position in the image forming system GS. This allows the user or the like to easily check where the image defects, which are generated on the conveyance of the sheet of paper P, such as image cracks, a roller trace and/or a scratch occur. Accordingly, it is possible to shorten a machine adjustment time by the user or the like and to reduce any downtime. As a result thereof, working property is also increased.

Further, since the position of the component selected on the automatic setting screen 400 or the like is highlighted, the user or the like may check the stop position set by himself visually so that it is possible to avoid wasting the sheet of paper or the like based on any wrong selection of stop position. Since the name of the selected component and/or its order number are represented, the user or the like may order the component appropriately and rapidly based on the represented information thereof when the image defects occur based on the selected component. When there are scare components, the user or the like may carry out the exchange thereof rapidly.

Additionally, according to the embodiments, since the user or the like may select plural components, he may check the image pattern formed on each of the sheets of paper stopped on each component at the same time so that it is possible to shorten an operation time as compared with a case where each sheet of paper stops at each stop position corresponding to each component and he checks a factor of image defects. In the manual setting of the conveyance checking mode, the stop position of each of the sheets of paper may be optionally set so that it is possible for the user or the like to perform a fine adjustment on the stop position of each of the sheets of paper according to the condition of the apparatus. This enables the user or the like to work while he check whether or not any troubles occur from outside. Since the guide plates each having the maximum curvature in the ADU 40 may be selected, the user or the like may check a portion which may scratch the sheet of paper P easily predominantly. When the sheet of paper which has been used in the image forming control is used and this sheet of paper is set to stop at the predetermined stop position, a sheet of paper on which any special image pattern is printed is unnecessary.

This invention is applicable to an image forming apparatus that forms an image on a sheet of paper, such as a copy machine, a facsimile, a printer and a multifunction printer.

Although the present invention has been described with reference to the embodiments above, it is to be noted that the present invention is not limited to the embodiments, and various changes and modifications are possible to those who are skilled in the art insofar as they are within the scope of the invention. For example, although in the above-mentioned embodiments, the positions in which image defects occur have been specified in the image forming apparatus 100, this invention is not limited thereto: When the finishing apparatus 600 is connected with the image forming apparatus 100 at a downstream side of the image forming apparatus 100, the conveying rollers and the guide plates of the finishing apparatus 600 may be selected so that it is possible to stop the sheet of paper P at a desired position of the finishing apparatus 600. Further, when a large capacity feeding apparatus, not shown, is connected with the image forming apparatus 100 at an upstream side of the image forming apparatus 100, the conveying rollers and the guide plates of this feeding apparatus may be selected so that it is possible to stop the sheet of paper P at a desired position of the feeding apparatus. Accordingly, it is possible to check and analyze the image defects occurring in an apparatus other than the image forming apparatus 100. This enables an image to be made highly defined. In the conveyance checking mode, present passing positions of the conveyed sheets of paper P may be displayed one by one on the reduced screen 440 of the automatic setting screen 400 or the like.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus which forms an image on a sheet of paper, the apparatus comprising:
a sheet conveying portion that conveys the sheet of paper in the image forming apparatus;
a setting portion that sets a stop position of the sheet of paper conveyed by the sheet conveying portion; and
a control portion that controls the sheet conveying portion to stop the sheet of paper at the stop position set by the setting portion,
wherein the setting portion selects any of plural stop positions as the stop position of the sheet of paper, and
the control portion is configured so as to stop a number of sheets of paper according to a number of the plural stop positions at the selected plural stop positions when the setting portion selects the plural stop positions.

2. The image forming apparatus according to claim 1 further comprising:
a display portion that displays the stop positions set by the setting portion.

3. The image forming apparatus according to claim 2 wherein the setting portion selects as the stop positions components used for conveying the sheet of paper, and
when the setting portion selects the components, the control portion controls the display portion to display information about the selected components.

4. The image forming apparatus according to claim 3 wherein the information about the selected components is at least one piece of information of name information of the components and identification number information of the components.

5. The image forming apparatus according to claim 1 wherein the setting portion sets to move each of the sheets of paper from their stop positions after the sheets of papers stop at their stop positions, and
the control portion controls the sheet conveying portion to move each of the sheets of paper from their stop positions according to an amount of movement set by the setting portion when the setting portion sets to move each of the sheets of paper from their stop positions after the sheets of paper stop at their stop positions.

6. The image forming apparatus according to claim 1 wherein the setting portion sets the stop positions of the sheets of paper at optional positions, and
the control portion controls the sheet conveying portion to stop the sheets of paper at any of the stop positions when the setting portion sets the stop positions of the sheets of paper at the optional positions.

7. The image forming apparatus according to claim 1 wherein the setting portion sets a conveying speed of each of the sheets of paper to a conveying speed of each of the sheets of paper that is different from a conveying speed of each of the sheets of paper in image forming control time when the image is formed on each of the sheets of paper.

8. The image forming apparatus according to claim 1 wherein the control portion controls the sheet conveying portion to stop the sheets of paper, which are used under an image forming control to form the image on the sheets of paper, at the stop positions set by the setting portion.

9. The image forming apparatus according to claim 1 wherein the setting portion selects at least one of sheet conditions among a feeding tray for containing the sheets of paper, a species of the sheet of paper and a size of the sheet of paper, and
the control portion controls the sheet conveying portion to stop the sheets of paper, which are used based on the sheet condition selected by the setting portion, at their stop positions set by the setting portion.
